(19) United States
(12) Patent Application Publication
(10) Pub. No.: US 2015/0349562 A1
(43) Pub. Date: Dec. 3, 2015

(54) SWITCHING POWER SUPPLY AND CHARGING APPARATUS

(71) Applicant: Panasonic Intellectual Property Management Co., Ltd., Osaka (JP)

(72) Inventors: AKIRA MINEGISHI, Osaka (JP); SHOICHI HARA, Osaka (JP)

(21) Appl. No.: 14/722,440

(22) Filed: May 27, 2015

(30) Foreign Application Priority Data
Jun. 2, 2014 (JP) 2014-113710
Dec. 24, 2014 (JP) 2014-260107

(51) Int. Cl. H02J 7/00; H02M 3/335

(52) U.S. Cl. CPC H02J 7/0052; H02M 3/33507

(57) ABSTRACT

A switching power supply includes a DC/AC inverter, an AC/DC converter, a first capacitor that passes an alternating current outputted from the DC/AC inverter, a second capacitor that passes the alternating current, and a reactor that passes part of the alternating current. An output voltage from the AC/DC converter is adjusted by a change of the period in which the reactor passes the part of the alternating current.

### BACKGROUND

1. Technical Field

The present disclosure relates to a switching power supply, such as a DC/DC converter, and a charging apparatus including the same.

2. Description of the Related Art

An isolated switching power supply includes a circuit that isolates a switching circuit and a load from each other (hereafter referred to as an isolation circuit). Typically, a transformer is used in an isolation circuit. On the other hand, there have been proposed isolated switching power supplies which each use a capacitor in an isolation circuit for downsizing or other purposes (for example, see Japanese Unexamined Patent Application Publication No. 8-23672 and Japanese Patent No. 4647713).

### SUMMARY

However, these traditional technologies do not allow for realizing both an isolation using a capacitor and a step-up or a step-down of the power-supply voltage.

In one general aspect, the techniques disclosed here feature a switching power supply. The switching power supply includes a DC/AC inverter that converts a received a direct current into an alternating current and includes a switching circuit, an AC/DC converter that converts an alternating current outputted from the DC/AC inverter into a direct current, a first capacitor disposed in a first current path connecting one output of the DC/AC inverter and one input of the AC/DC converter, the first capacitor passing an alternating current outputted from the DC/AC inverter, a second capacitor disposed in a second current path connecting the other output of the DC/AC inverter and the other input of the AC/DC converter, the second capacitor passing an alternating current outputted from the DC/AC inverter, and a reactor disposed in a third current path connecting the one input and the other input of the AC/DC converter, the reactor passing part of an alternating current outputted from the DC/AC inverter. By changing the period in which the reactor passes the part of the alternating current, an output voltage from the AC/DC converter is adjusted.

According to the present disclosure, it is possible to step up or down the power-supply voltage while realizing isolation using the capacitor.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a circuit diagram of a switching power supply according to a first embodiment;

FIG. 2 is a circuit diagram showing details of the circuit diagram shown in FIG. 1;

FIG. 3 is a circuit diagram showing the current in the circuit shown in FIG. 2;

FIG. 4 is a circuit diagram showing the current in the circuit shown in FIG. 2;

FIG. 5 is a circuit diagram of a switching power supply according to a comparative example;

FIG. 6 is a graph showing the results of a simulation on the switching power supply according to the comparative example;

FIG. 7 is a graph showing the results of a simulation on the switching power supply according to the first embodiment;

FIG. 8 is an equivalent circuit diagram of the circuit shown in FIG. 2;

FIG. 9 is a circuit diagram of a modification of the switching power supply according to the first embodiment;

FIG. 10 is a diagram showing a schematic configuration of a switching power supply according to a second embodiment;

FIG. 11 is a circuit diagram showing details of the circuit diagram shown in FIG. 10;

FIG. 12 is a diagram showing the current flow in the circuit shown in FIG. 11;

FIG. 13 is a diagram showing the current flow in the circuit shown in FIG. 11;

FIG. 14 is a diagram showing a switching power supply according to a comparative example;

FIG. 15 is a graph showing the results of a simulation on the switching power supply according to the comparative example;

FIG. 16 is a graph showing the results of a simulation on the switching power supply according to the second embodiment;

FIG. 17 is a block diagram showing the configuration of a charging apparatus according to a third embodiment;

FIG. 18A is a diagram showing an example operation of a switching element;

FIG. 18B is a diagram showing an example operation of a switching element;

FIG. 18C is a diagram showing an example operation of a switching element; and

FIG. 19 is a diagram showing an example of a bi-directional DC/DC converter circuit.

### DETAILED DESCRIPTION

### First Embodiment

### Underlying Knowledge Forming Basis of One Aspect According to First Embodiment

The present inventor found that when a switching circuit (particularly, a bridge switching circuit) performed a switching operation at a higher switching speed, a higher surge current flowed through the switching circuit, a first capacitor, and a second capacitor. A surge current causes the breakdown of the switching circuit, first capacitor, and second capacitor. The high-frequency component of the surge current causes high-frequency noise. The inventor made a first embodiment in order to reduce a surge current which accompanies a switching operation.

### Outline of One Aspect of First Embodiment

A switching power supply according to one aspect of the first embodiment includes a DC/AC inverter that converts a received a direct current into an alternating current and includes a switching circuit, an AC/DC converter that converts an alternating current outputted from the DC/AC inverter into a direct current, a first capacitor disposed in a first current path connecting one output of the DC/AC inverter and one input of the AC/DC converter, the first capacitor passing an alternating current outputted from the DC/AC inverter, a second capacitor disposed in a second current path connecting the other output of the DC/AC inverter and the other input of the AC/DC converter, the second capacitor passing an alternating current outputted from the DC/AC inverter, and a reactor disposed in a third current path connecting the one input and the other input of the AC/DC converter, the reactor passing part of an alternating current outputted from the DC/AC inverter.

In the above configuration, since the one input terminal and the other input terminal of the AC/DC converter are connected through the reactor, the current accumulated in the reactor can reduce a temporal change in the current flowing through the switching circuit, first capacitor, and second capacitor which occurs when the switching circuit performs switching. Thus, when the switching circuit performs switching, a surge current can be reduced which flows through the switching circuit, first capacitor, and second capacitor.

The respective impedances of the first and second capacitors are lower than or equal to the combined impedance of a parallel circuit formed by a load including the AC/DC converter, and the reactor at the switching frequency of the switching circuit (first condition). The impedance of the reactor is higher than or equal to the impedance of the load at the switching frequency of the switching circuit (second condition).

By satisfying the first condition, the input voltage of the switching circuit can be reliably transmitted to a second load. By satisfying the second condition, the current can flow through the second load.

The load including the AC/DC converter is formed by the AC/DC converter and a first load connected to the output terminal of the AC/DC converter. The reactor has an inductance such that the energy that the reactor can accumulate becomes one-half the power consumed by the first load. Thus, the current which flows through the reactor when the switching circuit operates can form a triangle wave which peaks when multiple transistors included in the switching circuit switch between on and off. This means that the first capacitor, second capacitor, and reactor are resonant, allowing the surge reduction effect to be maximized. That is, abrupt changes in the voltages on the multiple transistors included in the switching circuit, the first capacitor, and the second capacitor when the transistors switch between on and off can be reduced to the greatest extent possible. As a result, the surge current reduction effect can be maximized. The energy accumulated in the reactor is represented by a formula (L×I²)/2 where L is the inductance of the reactor; and I represents the current flowing through the reactor.

### Details of First Embodiment

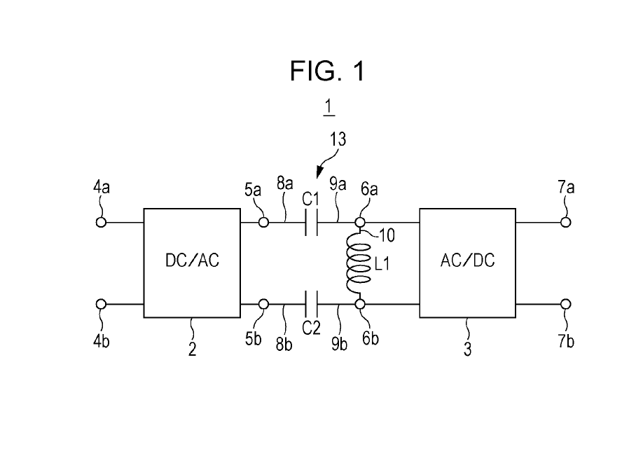

FIG. 1 is a circuit diagram of a switching power supply 1 according to the first embodiment. The switching power supply 1 is, for example, a DCDC converter. The switching power supply 1 includes a DC/AC inverter 2, an AC/DC converter 3, a first capacitor C1, a second capacitor C2, and a reactor L1. To prevent an electric shock, the input side and output side of the switching power supply 1 are isolated from each other by the first capacitor C1 and second capacitor C2. This means that a power transmission cannot be realized by using a direct current. For this reason, a direct current inputted to the switching power supply 1 is converted into an alternating current, which is in turn converted into a direct current and then outputted.

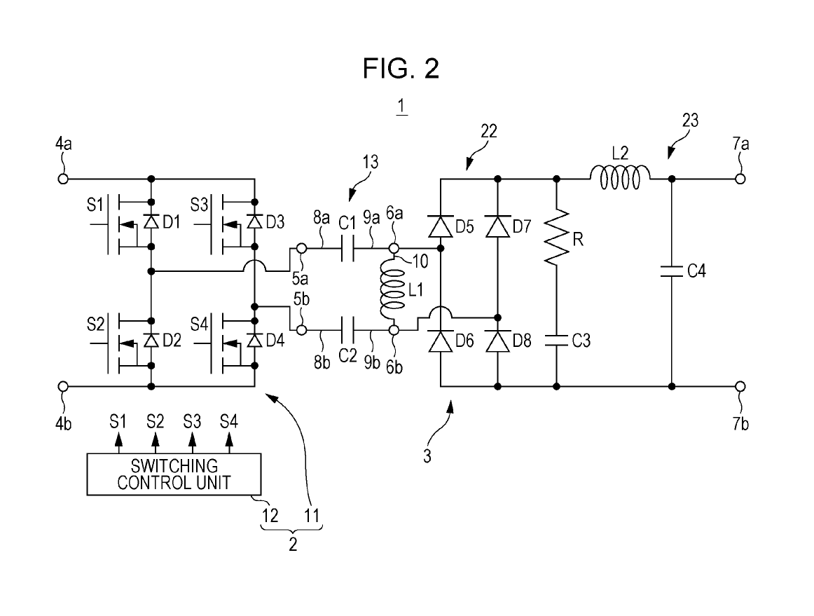

The DC/AC inverter 2 includes a bridge switching circuit 11 (shown in FIG. 2), input terminals 4a and 4b, and output terminals 5a and 5b. The switching circuit 11 converts a direct current received at between the input terminal 4a and 4b into an alternating current and then outputs it from between the output terminal 5a and 5b.

The output terminal 5a of the DC/AC inverter 2 is connected to one electrode of the first capacitor C1 through a line 8a. The output terminal 5b of the DC/AC inverter 2 is connected to one electrode of the second capacitor C2 through a line 8b.

The AC/DC converter 3 includes input terminals 6a and 6b and output terminals 7a and 7b. The input terminal 6a of the DC/AC inverter 3 is connected to the other electrode of the first capacitor C1 through a line 9a. The input terminal 6b of the DC/AC inverter 3 is connected to the other electrode of the second capacitor C2 through a line 9b.

The alternating current outputted from between the output terminal 5a and 5b of the DC/AC inverter 2 flows through the first capacitor C1 and second capacitor C2 and is inputted to the AC/DC converter 3 from between the input terminal 6a and 6b. The AC/DC converter 3 converts the inputted alternating current into a direct current and outputs it from between the output terminal 7a and 7b.

As seen above, the first capacitor C1 is disposed in a first current path (lines 8a, 9a) connecting one output terminal (output terminal 5a) of the DC/AC inverter 2 and one input terminal (input terminal 6a) of the AC/DC converter 3. The first capacitor C1 passes the alternating current outputted from the DC/AC inverter 2. The second capacitor C2 is disposed in a second current path (lines 8b, 9b) connecting the other output terminal (output terminal 5b) of the DC/AC inverter 2 and the other input terminal (input terminal 6b) of the AC/DC converter 3. The second capacitor C2 passes the alternating current outputted from the DC/AC inverter 2.

The first capacitor C1 and second capacitor C2 serve as an isolation circuit 13 that isolates the DC/AC inverter 2 and AC/DC converter 3 from each other. The first capacitor C1 and second capacitor C2 may be referred to as isolation capacitors.

The input terminals 6a and 6b of the AC/DC converter 3 are connected through a line 10 including the reactor L1. Thus, part of the alternating current outputted from between the output terminal 5a and 5b of the DC/AC inverter 2 flows through the reactor L1. Note that the lines 9a and 9b may be connected through the line 10 including the reactor L1. As seen above, the reactor L1 is disposed in a third current path (line 10) connecting one input terminal (input terminal 6a) and the other input terminal (input terminal 6b) of the AC/DC converter 3, and the part of the alternating current outputted from the DC/AC inverter 2 flows through the reactor L1.

The reactor L1 temporarily accumulates the part of the alternating current to be inputted to the AC/DC converter 3 (i.e., the secondary-side alternating current). That is, the reactor L1 has a function of buffering the secondary-side alternating current.

FIG. 2 is a circuit diagram showing details of the circuit diagram shown in FIG. 1. FIG. 2 shows the circuit configurations of the DC/AC inverter 2 and AC/DC converter 3.

The DC/AC inverter 2 includes the switching circuit 11 and a switching control unit 12. The DC/AC inverter 2 converts an inputted direct current into an alternating current using the switching circuit 11 and outputs it.

The switching circuit 11 is a full-bridge switching circuit where four transistors S1, S2, S3, and S4 are bridge-connected. As seen above, the switching circuit 11 includes the bridge-connected multiple transistors.

For example, the switching control unit 12 controls the transistors S2 and S3 so that these transistors are off while controlling the transistors S1 and S4 so that these transistors are on. On the other hand, the switching control unit 12 controls the transistors S2 and S3 so that these transistors are on while controlling the transistors S1 and S4 so that these transistors are off.

The switching circuit 11 also includes four free-wheeling diodes D1, D2, D3, and D4. The free-wheeling diode D1 is connected to the source and drain of the transistor S1 so that a current having a predetermined direction flows therebetween. The expression “a current having a predetermined direction” refers to a current having a direction opposite to the direction of the current which flows through the transistor S1 when the transistor S1 is on. Similarly, the free-wheeling diode D2 is connected to the source and drain of the transistor S2; the free-wheeling diode D3 to the source and drain of the transistor S3; and the free-wheeling diode D4 to the source and drain of the transistor S4.

The AC/DC converter 3 includes a rectifier circuit 22, a smoothing capacitor C3, and a low-pass filer 23.

The rectifier circuit 22 is a bridge rectifier circuit where four diodes D5, D6, D7, and D8 are bridge-connected. The rectifier circuit 22 converts the alternating current inputted to between the input terminal 6a and 6b into a direct current by full-wave rectifying the alternating current. The smoothing capacitor C3 smoothes the direct current. The low-pass filer 23 includes a coil L2 and a capacitor C4. The low-pass filer 23 eliminates noise from the smoothed direct current. The resulting direct current is outputted from between the output terminal 7a and 7b.

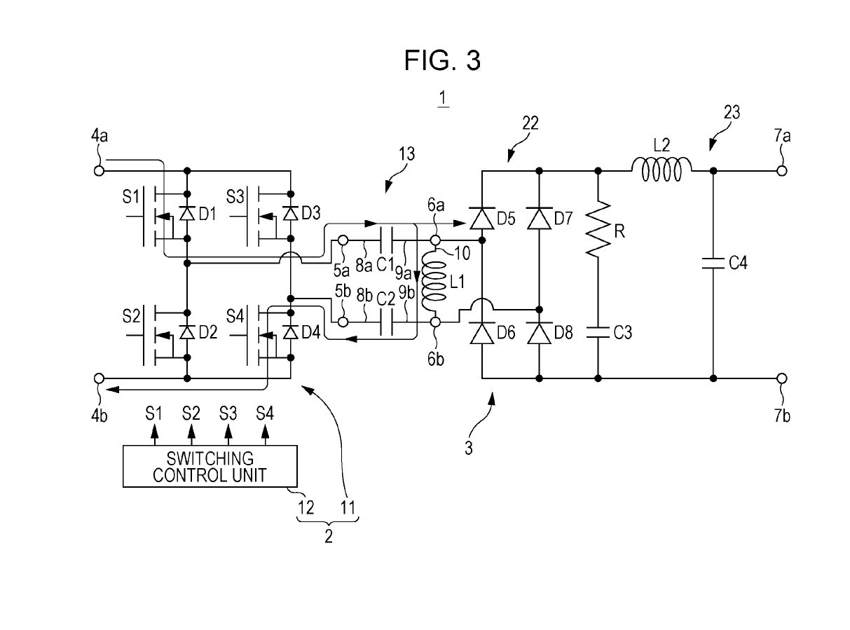

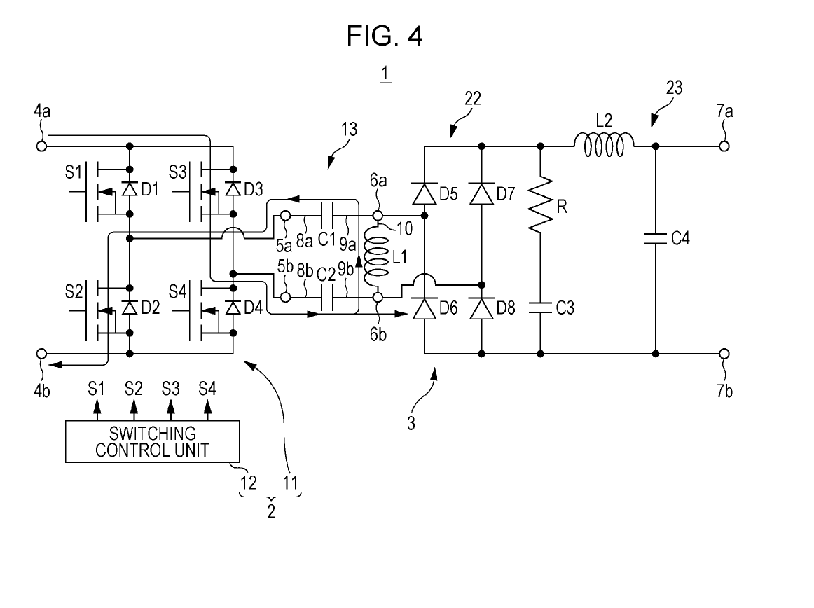

FIG. 3 shows a current which flows through the switching circuit 11, first capacitor C1, second capacitor C2, and reactor L1 when the transistors S1 and S4 are on and the transistors S2 and S3 are off in the circuit shown in FIG. 2. On the other hand, FIG. 4 shows a current which flows through the switching circuit 11, first capacitor C1, second capacitor C2, and reactor L1 when the transistors S1 and S4 are off and the transistors S2 and S3 are on in the circuit shown in FIG. 2. As seen in these diagrams, all of the alternating current outputted from the switching circuit 11 does not flow into the rectifier circuit 22, and part thereof flows into the reactor L1.

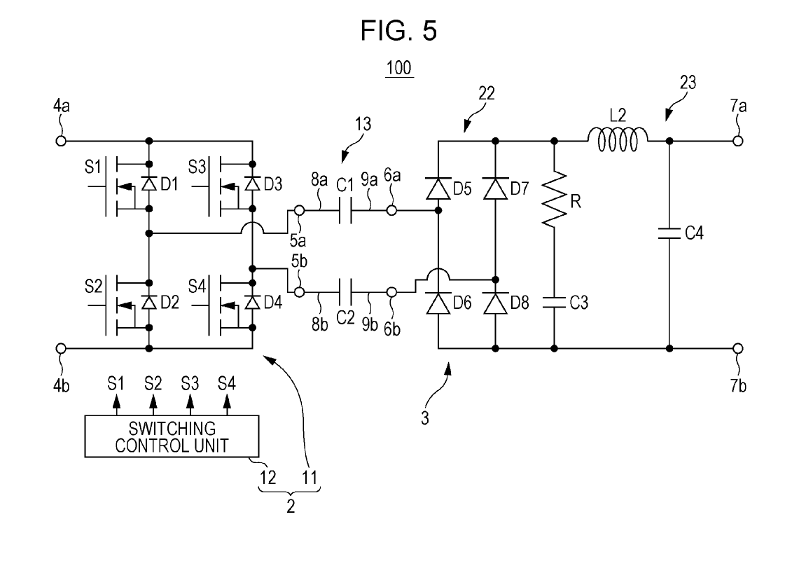

According to the first embodiment, by connecting the input terminal 6a and input terminal 6b of the AC/DC converter 3 through the reactor L1, the surge current can be reduced. This will be described in comparison with a switching power supply 100 according to a comparative example shown in FIG. 5. The switching power supply 100 has the same configuration as the switching power supply 1 according to the first embodiment shown in FIG. 2 except that it does not include the line 10, which connects the input terminal 6a and input terminal 6b and includes the reactor L1.

With respect to the switching power supply 1 according to the first embodiment shown in FIG. 2 and the switching power supply 100 according to the comparative example shown in FIG. 5, the currents passing therethrough and the like were calculated using a simulator.

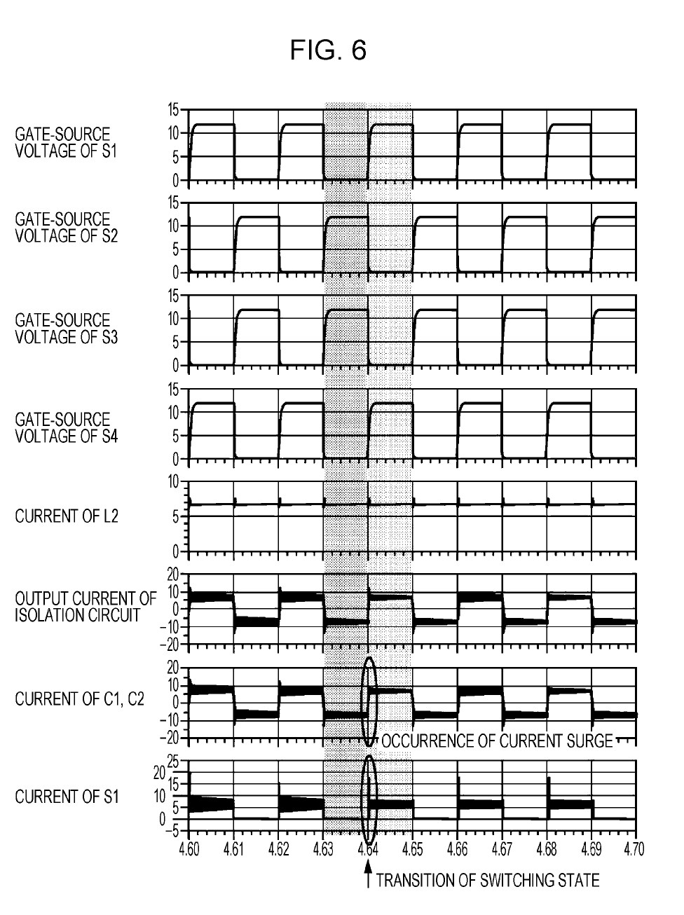

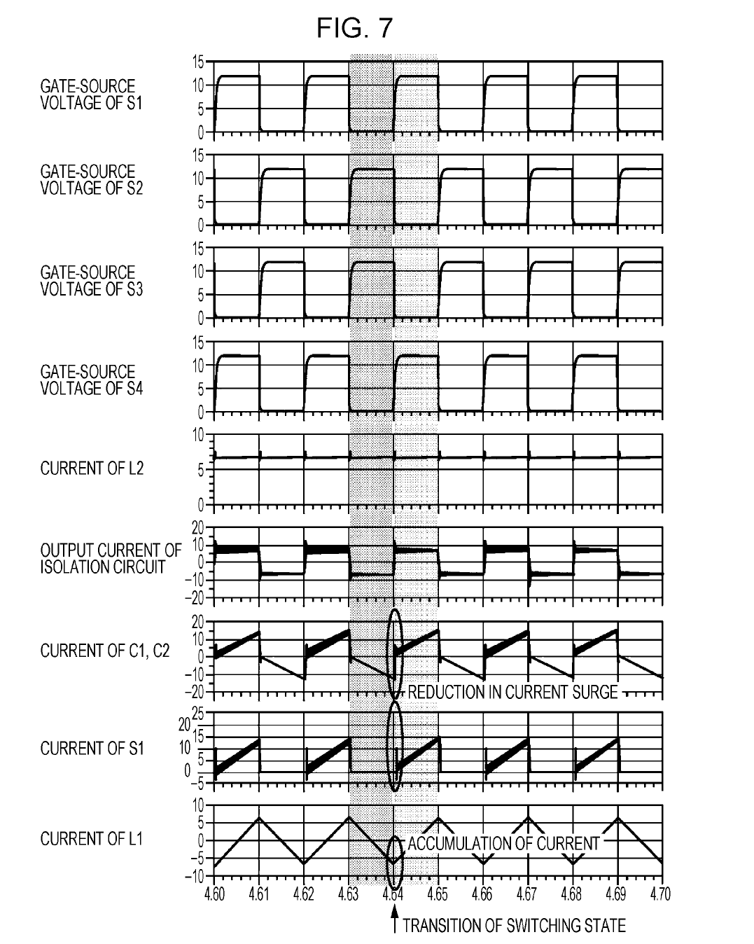

In these simulations, the switching frequency of the transistors S1, S2, S3, and S4 was set to 65 kHz; the capacitances of the first capacitor C1 and second capacitor C2 were set to 10 μF; and the inductance of the reactor L1 was set to 300 pH. The simulation results are shown in FIGS. 6 and 7. FIG. 6 includes graphs showing the results of the simulation on the switching power supply 100 according to the comparative example. FIG. 7 includes graphs showing the results of the simulation on the switching power supply 1 according to the first embodiment. The vertical axis of each graph represents the voltage in volts (V) or the current in amperes (A). The horizontal axis of each graph represents the time in milliseconds.

Referring to FIGS. 6 and 7, when a voltage H was applied between the gate and source of each of the transistors S1 and S4, the transistors S1 and S4 were turned on. In contrast, when a voltage L was applied between the gate and source of each of the transistors S1 and S4, the transistors S1 and S4 were turned off. Similarly, when a voltage H was applied between the gate and source of each of the transistors S2 and S3, the transistors S2 and S3 were turned on. In contrast, when a voltage L was applied between the gate and source of each of the transistors S2 and S3, the transistors S2 and S3 were turned off.

That is, when the transistors S1 and S4 were kept on, the transistors S2 and S3 were kept off. When the transistors S1 and S4 were kept off, the transistors S2 and S3 were kept on.

A direct current from the AC/DC converter 3 flowed through the coil L2.

The output current of the isolation circuit 13 represents an alternating current. More specifically, when the transistors S1 and S4 were on and the transistors S2 and S3 were off, the isolation circuit 13 outputted approximately a constant positive current. In contrast, when the transistors S1 and S4 were off and the transistors S2 and S3 were on, the isolation circuit 13 outputted approximately a constant negative current. When the transistors S1 and S4 were switched from on to off and the transistors S2 and S3 were switched from off to on, the output current of the isolation circuit 13 was changed from positive to negative. In contrast, when the transistors S1 and S4 were switched from off to on and the transistors S2 and S3 were switched from on to off, the output current of the isolation circuit 13 was changed from negative to positive.

The current flowing through the transistors S1, S2, S3, and S4 will be described using the current flowing through the transistor S1 as an example. As used herein, the current flowing through the transistor S1 refers to a current flowing between the source and drain of the transistor S1.

Referring to FIG. 7, the current flowing through the reactor L1 forms a triangle wave. This will be described in detail later.

Referring to FIG. 6, in the switching power supply 100 according to the comparative example, when the transistors S1 and S4 were on and the transistors S2 and S3 were off, approximately a constant positive current flowed through the first capacitor C1 and second capacitor C2. In contrast, when the transistors S1 and S4 were off and the transistors S2 and S3 were on, approximately a constant negative current flowed through the first capacitor C1 and second capacitor C2. In this comparative example, the alternating current flowing through the first capacitor C1 and second capacitor C2 had the same amplitude as the output current of the isolation circuit 13. Further, in this comparative example, when the transistors S1 and S4 were on and the transistors S2 and S3 were off, approximately a constant positive current flowed through the transistor S1.

On the other hand, referring to FIG. 7, in the switching power supply 1 according to the first embodiment, when the transistors S1 and S4 were on and the transistors S2 and S3 were off, the current flowing through the first capacitor C1 and second capacitor C2 increased like a linear function. In contrast, when the transistors S1 and S4 were off and the transistors S2 and S3 were on, the current flowing through the first capacitor C1 and second capacitor C2 decreased like a linear function. Further, in the first embodiment, when the transistors S1 and S4 were on and the transistors S2 and S3 were off, the current flowing through the transistor S1 increased like a linear function.

When the switching state makes a transition, a surge current occurs. There are two types of switching state transition. One is a switching state transition in which the transistors S1 and S4 which are on are turned off and the transistors S2 and S3 which are off are turned on. Thus, the current flow shown in FIG. 3 is changed to the current flow shown in FIG. 4. The other is a switching state transition in which the transistors S1 and S4 which are off are turned on and the transistors S2 and S3 which are on are turned off. Thus, the current flow shown in FIG. 4 is changed to the current flow shown in FIG. 3.

When such a switching state transition occurs, the current flowing through the switching circuit 11 or isolation circuit 13 suddenly changes its path. Thus, a surge current flows through the first capacitor C1, second capacitor C2, and the transistors S1, S2, S3, and S4.

In the switching power supply 100 according to the comparative example, as shown in FIG. 6, the above path change abruptly changes the current flowing through the first capacitor C1, second capacitor C2, and transistor 1. Thus, relatively high surge currents flow through the first capacitor C1, second capacitor C2 and transistor S1. Specifically, a surge current of about 10 A flows through the first capacitor C1 and second capacitor C2, and a surge current of about 18 A flows through the transistor S1.

On the other hand, in the present embodiment, surge currents lower than those in the comparative example flow through the first capacitor C1, second capacitor C2, and transistor S1. Specifically, a surge current of about 5 A flows through the first capacitor C1 and second capacitor C2, and a surge current of about 11 A flows through the transistor S1.

The reason why the switching power supply 1 according to the first embodiment can reduce the surge current compared to the switching power supply 100 according to the comparative example is as follows. As shown in FIG. 3, when the transistors S1 and S4 are on, part of the alternating current outputted from the switching circuit 11 flows into the reactor L1 and is accumulated therein as energy. To switch the transistors S1 and S4 from off to on, it is necessary to supply a predetermined amount of current from the outside to the transistors S1 and S4, first capacitor C1, and second capacitor C2. As this current increases, the surge current increases as well. In the first embodiment, the reactor L1 also supplies a current to the transistors S1 and S4, first capacitor C1, and second capacitor C2. Accordingly, the current supplied from the outside to the transistors S1 and S4, first capacitor C1, and second capacitor C2 can be reduced, so that the surge current can be reduced.

Similarly, as shown in FIG. 4, when the transistors S2 and S3 are on, part of the alternating current outputted from the switching circuit 11 flows into the reactor L1 and is accumulated therein as energy. To switch the transistors S2 and S3 from off to on, it is necessary to supply a predetermined amount of current from the outside to the transistors S2 and S3, first capacitor C1, and second capacitor C2. As this current increases, the surge current increases as well. In the first embodiment, the reactor L1 also supplies a current to the transistors S2 and S3, first capacitor C1, and second capacitor C2. Accordingly, the current supplied from the outside to the transistors S2 and S3, first capacitor C1, and second capacitor C2 can be reduced, so that the surge current can be reduced.

As described above, in the switching power supply 1 according to the first embodiment shown in FIG. 2, the input terminal 6a and input terminal 6b of the AC/DC converter 3 are connected through the reactor L1. Thus, it is possible to reduce a surge current which flows through the switching circuit 11, first capacitor C1, and second capacitor C2 when the switching circuit 11 performs a switching operation. As a result, a switching power supply can be realized which is less likely to break down.

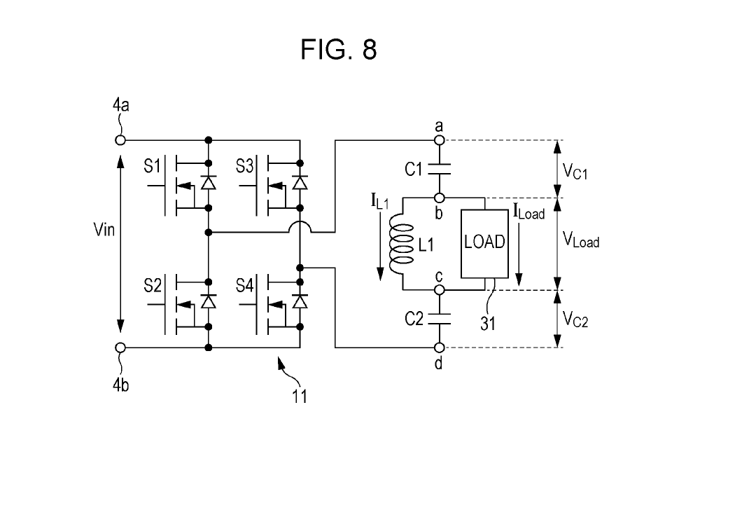

Next, the impedance conditions of the first capacitor C1, second capacitor C2, and reactor L1 will be described. FIG. 8 is an equivalent circuit diagram of the circuit shown in FIG. 2. A load 31 includes the AC/DC converter 3 shown in FIG. 2 and a first load (e.g., in-car secondary battery) connected to the output terminals 7a and 7b of the AC/DC converter 3. The load 31 is a specific example of the load including the AC/DC converter 3.

In FIG. 8, Vin represents a direct-current voltage inputted to between the input terminal 4a and 4b of the DC/AC inverter 2; I_{L1} represents the current flowing through the reactor L1; I_{Load} represents the current flowing through the load 31; V_{C1} represents a voltage applied to the first capacitor C1; V_{Load} represents a voltage applied to a parallel circuit formed by the reactor L1 and load 31; and V_{C2} represents a voltage applied to the second capacitor C2.

The b-c impedance, that is, the impedance Z₀₁ of the parallel circuit formed by the reactor L1 and load 31 is represented by Formula 1 below.

$${Z}_{01} = \frac{jω {L}_{1} \times {Z}_{Load}}{jω {L}_{1} + {Z}_{Load}} \qquad [ Formula 1 ]$$

where j represents an imaginary unit; ω represents a value represented by 2×π×fsw; fsw represents the switching frequency of the transistors S1, S2, S3, and S4; L₁ represents the inductance of the reactor L1; and Z_{Load} represents the impedance of the load 31. As used herein, the switching frequency refers to the frequency of the voltage applied to the gates of the transistors S1, S2, S3, and S4 included in the switching circuit 11.

To reliably transmit the input voltage (Vin) of the switching circuit 11 to the load 31, it is necessary to satisfy conditions represented by Formula 2 below.

$$\frac{1}{jω {C}_{1}} , \frac{1}{jω {C}_{2}} \leq \frac{jω {L}_{1} \times {Z}_{Load}}{jω {L}_{1} + {Z}_{Load}} \qquad [ Formula 2 ]$$

where C₁ represents the capacitance of the first capacitor C1; and C₂ represents the capacitance of the second capacitor C2.

Formula 2 above requires that the impedances of the first capacitor C1 and second capacitor C2 be lower than or equal to the combined impedance of the parallel circuit formed by the load 31 and reactor L1 at the switching frequency of the switching circuit 11.

To reliably pass the current through the load 31, it is necessary to satisfy a condition represented by Formula 3 below.

Z_{Load}≦jωL₁ [Formula 3]

Formula 3 above requires that the impedance of the reactor L1 be higher than or equal to the impedance of the load 31 at the switching frequency of the switching circuit 11.

Next, the current flowing through the reactor L1 shown in FIG. 7 will be described. The current flowing through the reactor L1 takes a positive peak value when the transistors S1 and S4 which are on are turned off and the transistors S2 and S3 which are off are turned on. In contrast, the current flowing through the reactor L1 takes a negative peak value when the transistors S1 and S4 which are off are turned on and the transistors S2 and S3 which are on are turned off.

As seen in FIG. 7, the current flowing through the reactor L1 forms a triangle wave which peaks when the switching circuit 11 operates, that is, when the transistors S1, S2, S3, and S4 switch between on and off.

This means that the first capacitor C1, second capacitor C2, and reactor L1 are resonant, thereby allowing the surge reduction effect to be maximized. That is, it is possible to reduce, to the greatest extent possible, abrupt changes in the voltages on the four transistors S1, S2, S3, and S4 included in the switching circuit 11, the first capacitor C1, and second capacitor C2 when these transistors switch between on and off. Thus, the surge current reduction effect can be maximized.

To allow the current flowing through the reactor L1 to form a triangle wave as described above, it is necessary to satisfy the conditions represented by Formulas 2 and 3 above, as well as a condition that the reactor L1 have an inductance such that energy which the reactor L1 can accumulate becomes one-half the power consumed by the load. The load here refers to the first load, which is connected to the output terminals 7a and 7b of the AC/DC converter 3. The energy accumulated in the reactor is represented by a formula (L×I²)/2 where L represents the inductance of the reactor; and I represents the current flowing through the reactor.

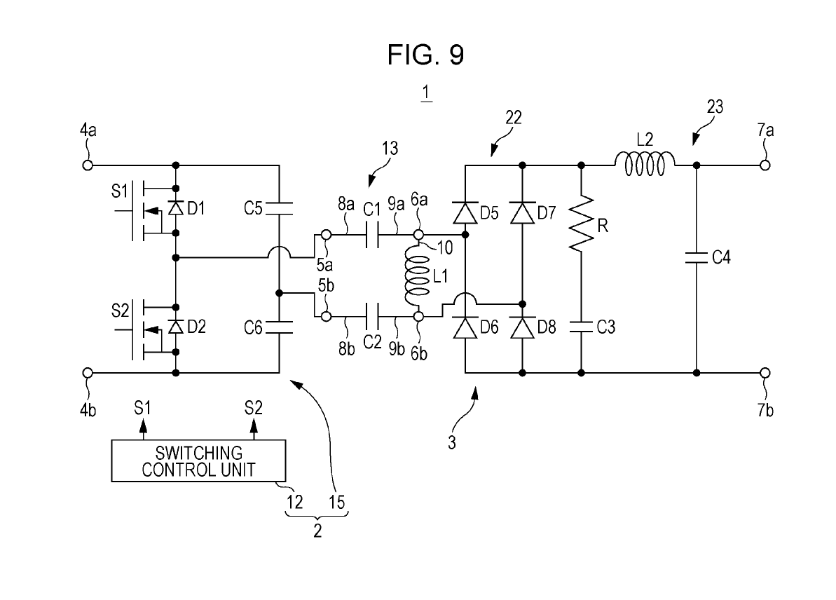

While the full-bridge switching circuit 11 shown in FIG. 2 has been described, a half-bridge switching circuit may be used as a switching circuit. A switching power supply including a half-bridge switching circuit will be described as a modification below. FIG. 9 is a circuit diagram of a modification of the switching power supply 1 according to the first embodiment. Elements different from those in the switching power supply 1 shown in FIG. 2 will be described, and the same elements are given the same reference signs and will not be described.

The switching power supply 1 shown in FIG. 9 includes a switching circuit 15 in place of the switching circuit 11 shown in FIG. 2. The switching circuit 15 is a half-bridge switching circuit where a transistor S1, a transistor S2, a capacitor C5, and a capacitor C6 are bridge-connected. The switching circuit 15 includes the capacitor C5 in place of the transistor S3 and includes the capacitor C6 in place of the transistor S4.

### Second Embodiment

A second embodiment will be described in detail below. Configurations common to the first and second embodiments will not be described in detail.

### Outline of One Aspect of Second Embodiment

A switching power supply according to one aspect of the second embodiment includes a DC/AC inverter that includes a switching circuit that converts a received direct current into an alternating current, an AC/DC converter that converts an alternating current outputted from the DC/AC inverter into a direct current, a first capacitor disposed in a first current path connecting one output of the DC/AC inverter and one input of the AC/DC converter, the first capacitor passing an alternating current outputted from the DC/AC inverter, a second capacitor disposed in a second current path connecting the other output of the DC/AC inverter and the other input of the AC/DC converter, the second capacitor passing an alternating current outputted from the DC/AC inverter, and a reactor disposed in a third current path connecting the one input and the other input of the AC/DC converter, the reactor passing part of an alternating current outputted from the DC/AC inverter. The AC/DC converter converts the alternating current, which the first capacitor and the second capacitor passed, into a direct current. By controlling (e.g., changing) the period in which the reactor passes the part of the alternating current, an output voltage from the AC/DC converter is controlled (e.g., adjusted). An output voltage from the AC/DC converter is adjusted by a change of the period in which the reactor passes the part of the alternating current.

According to the above configuration, it is possible to step up or down the power-supply voltage while realizing isolation using the capacitors.

The switching power supply according to one aspect according to the second embodiment may control (e.g., change) the period in which the reactor passes the part of the alternating current, by controlling (e.g., changing) the ratio between the on and off periods of the switching elements included in the switching circuit.

According to the above configuration, it is possible to more accurately control the step-up or step-down of the power-supply voltage.

In the switching power supply according to one aspect according to the second embodiment, the switching circuit may include a bridge circuit including first and second connection paths. The second connection path is connected to the first connection path in parallel. The first connection path includes a first switching element (e.g., transistor S1) and a second switching element (e.g., transistor S2). The second connection path includes a third switching element (e.g., transistor S3) and a fourth switching element (e.g., transistor S4). The first capacitor is connected to a path connecting the first and second switching elements. The second capacitor is connected to a path connecting the third and fourth switching elements. A period, in which the first and fourth switching elements are on and the second and third switching elements are off, is referred to as a first period. A period, in which the first and fourth switching elements are off and the second and third switching elements are on, is referred to as a second period. By extending at least one of the first period and the second period, the switching power supply according to one aspect according to the second embodiment may extend the period in which the reactor passes the part of the alternating current to increase the output voltage from the AC/DC converter.

### Details of Second Embodiment

According to the configuration of the first embodiment, the power-supply voltage is applied to a load while the DC/AC inverter outputs the current to the AC/DC converter. Further, part of the current flows into the reactor and thus energy is accumulated therein. Further, while the DC/AC inverter does not output the current to the AC/DC converter (that is, the DC/AC inverter is disconnected), the energy accumulated in the reactor flows into the AC/DC converter and is supplied to the load.

Accordingly, even when the DC/AC inverter is disconnected, the current can be supplied to the load. The voltage applied to the load depends on the voltage being outputted by the DC/AC inverter and the current supplied by the reactor during disconnection of the DC/AC inverter. Thus, the power-supply voltage can be stepped up or down using the ratio between the output time and disconnection time of the DC/AC inverter.

The switching power supply according to the second embodiment controls the output voltage from the AC/DC converter by controlling the period in which the reactor passes the part of the current. Thus, it is possible to step up or down the power-supply voltage while realizing isolation using the capacitors.

The switching power supply according to the second embodiment may control the period in which the reactor passes the part of the alternating current, by controlling the ratio between the on and off periods of at least one of switching elements included in the switching circuit. Thus, it is possible to more accurately control the step-up or step-down of the power-supply voltage.

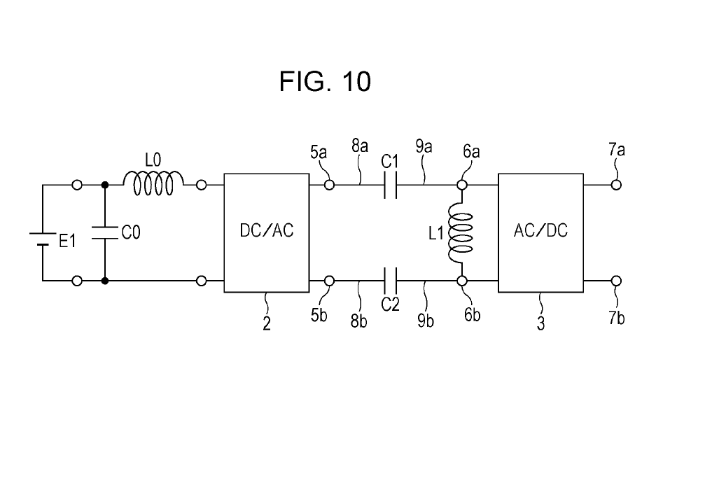

FIG. 10 is a diagram showing a schematic configuration of the switching power supply according to the second embodiment. The switching power supply of FIG. 10 includes the elements of the first embodiment shown in FIG. 1, as well as a voltage source E1, a reactor L0, and a capacitor C0. The reactor L0 is connected to the voltage source E1 in series. The smoothing capacitor C0 is connected to the voltage source E1 in parallel.

Thus, the switching power supply of FIG. 10 can operate as a current input-type switching power supply. That is, this switching power supply can input a current having a predetermined current value to a DC/AC inverter 2.

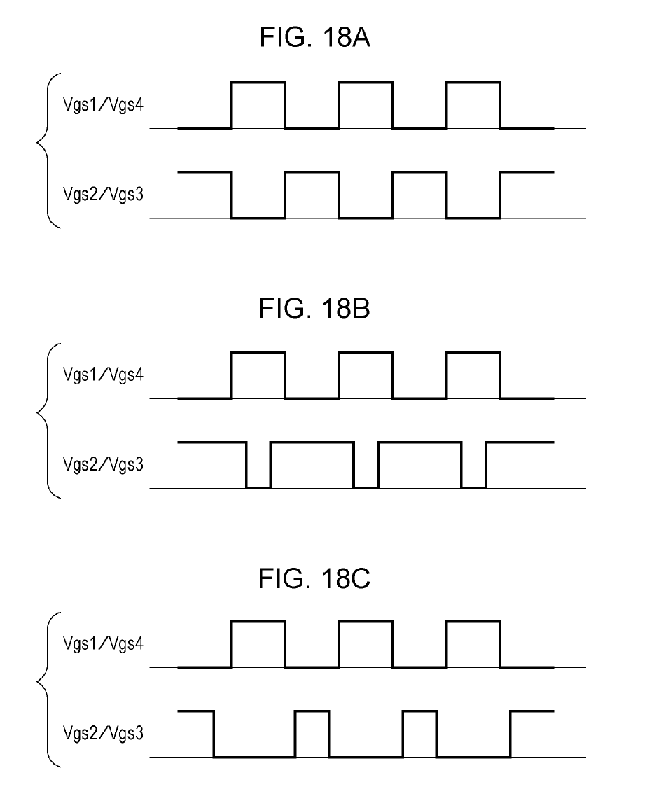

FIGS. 18A to 18C are diagrams each showing an example operation of the switching elements. As shown in FIG. 18B, the period in which both transistors S1 and S2 are on or the period in which both transistors S3 and S4 are on may be set as a longer period. Thus, the input current to the DC/AC inverter 2 can be increased compared to that in FIG. 18A. Also, as shown in FIG. 18C, the period in which all the transistors S1 to S4 are off may be set as a longer period. Thus, the input current to the DC/AC inverter 2 can be reduced compared to that in FIG. 18A.

The reactor L1 temporarily accumulates part of the alternating current to be inputted to the AC/DC converter 3 (i.e., the secondary-side alternating current). Thus, while the DC/AC inverter 2 does not output the current to the AC/DC converter 3, the reactor L1 outputs the accumulated power to the AC/DC converter 3.

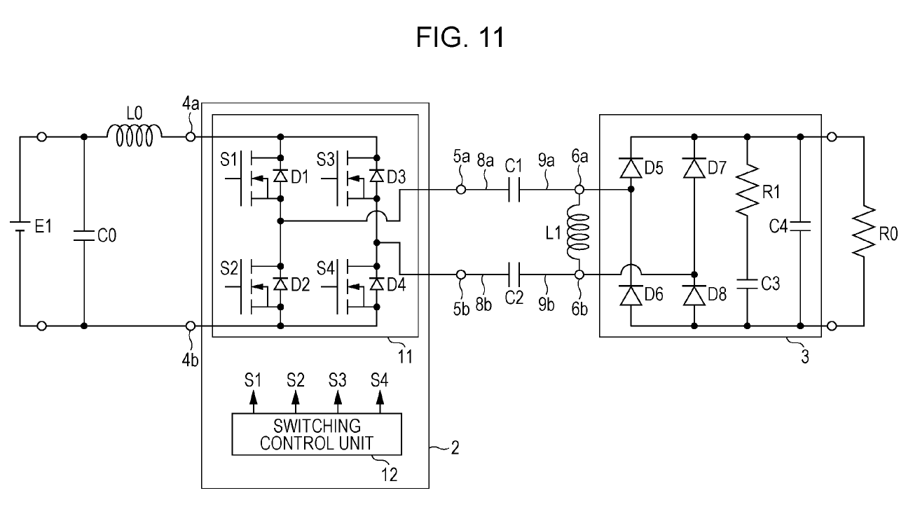

FIG. 11 is a circuit diagram showing details of the circuit diagram shown in FIG. 10. In FIG. 11, the switching power supply includes a snubber resistor R1, a snubber capacitor C3, and a smoothing capacitor C4 in place of the low-pass filter 23 of the first embodiment shown in FIG. 2.

The snubber resistor R1 and snubber capacitor C3 prevent a surge voltage which occurs when switching is performed. The smoothing capacitor C4 smoothes the full-wave rectified voltage to eliminate noise. The resulting direct current is outputted from an output terminal 7a or 7b to a load R0.

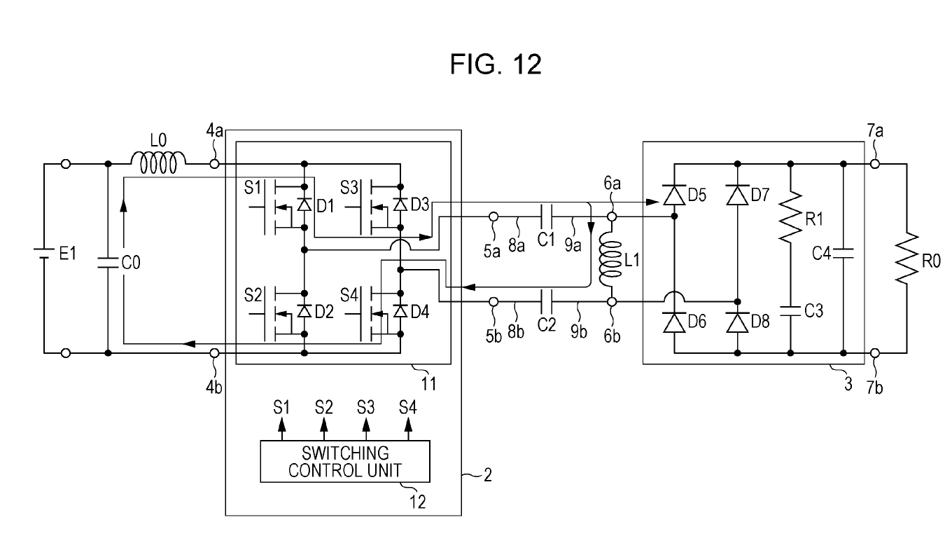

FIG. 12 is a diagram showing the current flow in the circuit shown in FIG. 11. FIG. 12 shows a current which flows through the switching circuit, first capacitor, second capacitor, and reactor when the transistors S1 and S4 are on and the transistors S2 and S3 are off.

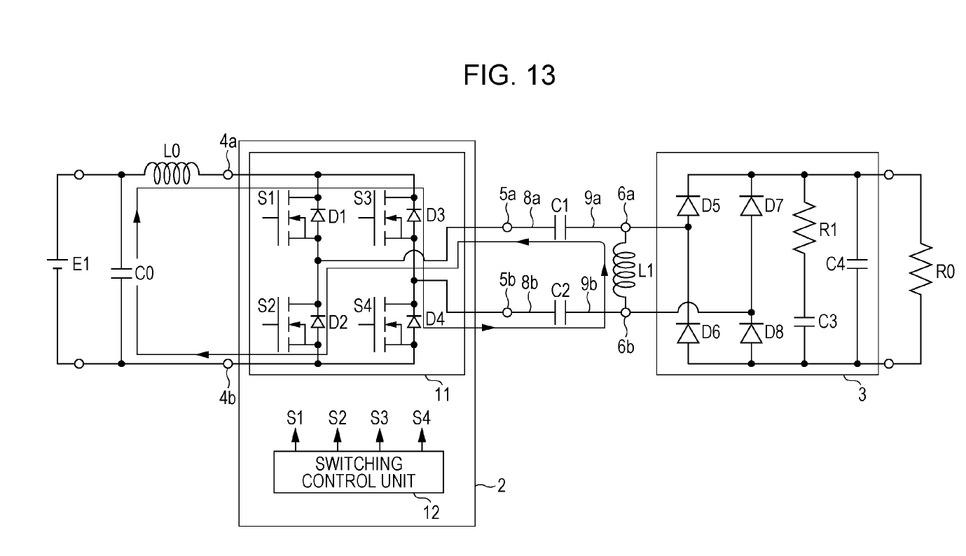

FIG. 13 is also a diagram showing the current flow in the circuit shown in FIG. 11. FIG. 13 shows a current which flows through the switching circuit 11, first capacitor C1, second capacitor C2, and reactor L1 when the transistors S1 and S4 are off and the transistors S2 and S3 are on.

As seen above, all of the alternating current outputted from the switching circuit 11 does not flow into the rectifier circuit 22, and part thereof flows into the reactor L1.

In the second embodiment, the input terminal 6a and input terminal 6b of the AC/DC converter 3 are connected through the reactor L1. Thus, for example, it is possible to output a voltage higher than or equal to the input voltage to the voltage source E1.

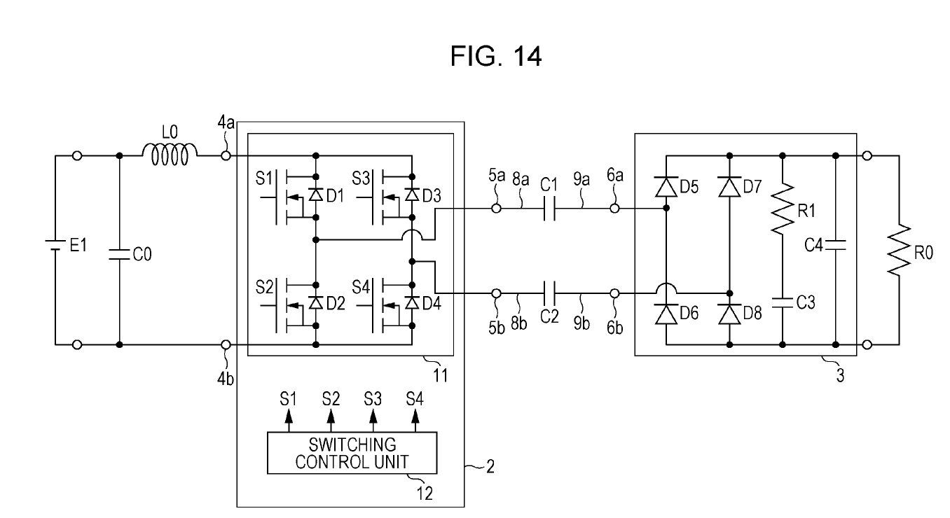

FIG. 14 is a diagram showing a switching power supply 100 according to a comparative example.

The switching power supply 100 according to the comparative example in FIG. 14 does not include the line 10 including the reactor L1 connecting input terminals 6a and 6b. This switching power supply has the same configuration as the switching power supply 1 according to the first embodiment shown in FIG. 11 except that it does not include a reactor L1.

With respect to the switching power supply 1 according to the first embodiment shown in FIG. 11 and the switching power supply 100 according to the comparative example shown in FIG. 14, the currents flowing therethrough and the like were calculated using a simulator.

In these simulations, the switching frequency of the transistors S1, S2, S3, and S4 was set to 100 kHz; the capacitances of the first capacitor C1 and second capacitor C2 were set to 10 uF; and the inductance of the reactor L1 was set to 10 uH.

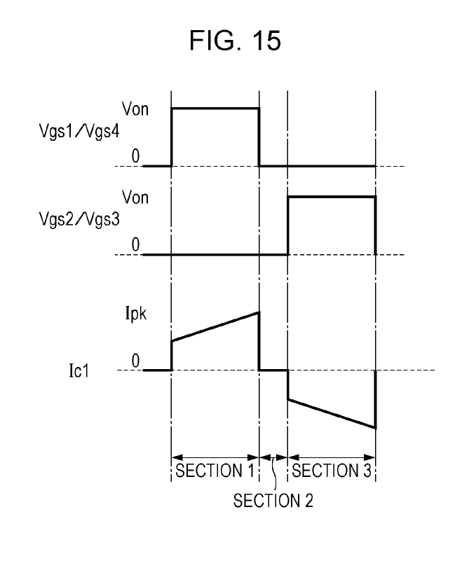

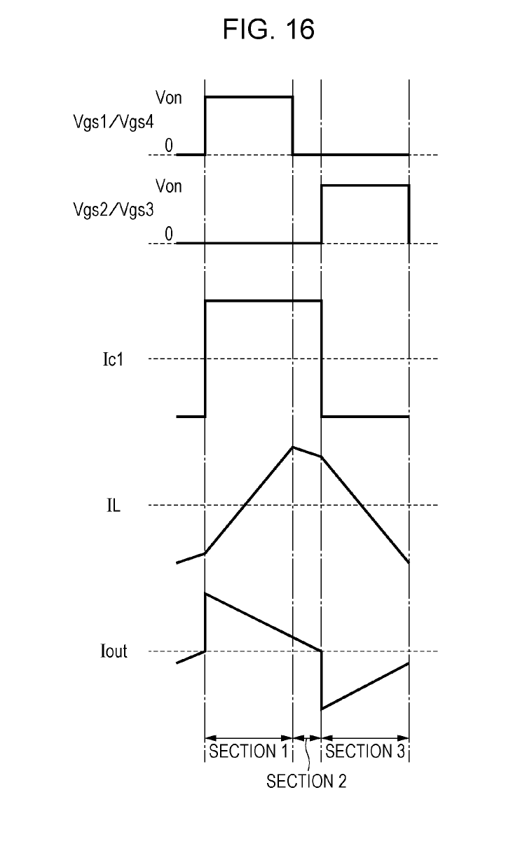

The simulation results are shown in FIGS. 15 and 16. In FIGS. 15 and 16, the vertical axis of each graph represents the voltage in volts (V) or the current in amperes (A), and the horizontal axis thereof represents the time in milliseconds.

FIG. 15 is a graph showing the results of the simulation on the switching power supply according to the comparative example. In FIG. 15, Vgs1/Vgs4 represents the gate voltage of transistors S1 and S4 in FIG. 14, and Vgs2/Vgs3 represents the gate voltage of transistors S2 and S3 in FIG. 14.

As shown in FIG. 15, when the voltage on each transistor becomes higher than equal to Von, the transistor is turned on; when the voltage on each transistor becomes lower than or equal to Von, the transistor is turned off.

In FIG. 15, Ic1 represents the current flowing through the capacitor C1 in FIG. 14. A waveform on the positive side indicates the period in which the current is flowing from the terminal 5 to the terminal 6. That is, the inverter is supplying the current to the load. A waveform on the negative side indicates the period in which the current is flowing from the terminal 6 to the terminal 5. That is, the current is flowing from the load to the inverter.

Note that the current flowing through the capacitor C2 in FIG. 14 has a value obtained by inverting the sign of Ic1 in FIG. 15.

In a section 1 of FIG. 15, the transistors S1 and S4 are on, and the transistors S2 and S3 are off. In a section 2 of FIG. 15, all the transistors are off. In a section 3 of FIG. 15, the transistors S1 and S4 are off, and the transistors S2 and S3 are on.

As shown in FIG. 15, in the switching power supply according to the comparative example, in the section 1, the sawtooth current flows through the load, applying the voltage thereof to the load.

On the other hand, in the section 2, the current does not flow through the load and therefore the power supply does not apply the voltage to the load. For this reason, the charge accumulated in the capacitor is supplied to the load as it is and thus the voltage is not maintained.

As a result, the switching power supply according to the comparative example cannot apply a voltage higher than or equal to the power-supply voltage to the load.

FIG. 16 is a graph showing the results of the simulation on the switching power supply according to the second embodiment.

In FIG. 16, Vgs1/Vgs4 represents the gate voltage of the transistors S1 and S4 in FIG. 11; Vgs2/Vgs3 represents the gate voltage of the transistors S2 and S3 in FIG. 11; and Ic1 represents the current flowing through the capacitor C1 in FIG. 11. A waveform on the positive side indicates the period in which the current is flowing from the terminal 5 to the terminal 6. That is, the inverter is supplying the current to the load. A waveform on the negative side indicates the period in which the current is flowing from the terminal 6 to the terminal 5. That is, the current is flowing from the load to the inverter.

Note that the current flowing through the capacitor C2 in FIG. 11 has a value obtained by inverting the sign of Ic1 in FIG. 16.

In FIG. 16, IL represents the current flowing through the reactor L1 in FIG. 11. A waveform on the positive side indicates the period in which the current is flowing from a terminal 6a to a terminal 6b. A waveform on the negative side indicates the period in which the current is flowing from the terminal 6b to the terminal 6a.

In FIG. 16, Iout represents the output voltage in FIG. 11. A waveform on the positive side indicates the period in which the current is flowing from the terminal 6a to a diode D5. That is, the current is flowing from the inverter to the load. A waveform on the negative side indicates the period in which the current is flowing from a diode D7 to the terminal 6a. That is, the current is flowing from the load to the inverter.

In a section 1 of FIG. 16, transistors S1 and S4 are on, and the transistors S2 and S3 are off.

As shown in FIG. 16, in the switching power supply according to the second embodiment, in the section 1, a predetermined current flows from the current source, the reactor L0, to the capacitor C1.

At the start point of the section 1, the reactor L1 also supplies a current to the terminal 6a, since the reactor L1 has energy accumulated in the preceding period. The supplied current flows from the terminal 6a to the load, thereby increasing the voltage on the load.

When the current accumulated in the reactor L1 is smaller than the current consumed by the load, the amount of the charge held in C2 on the load side decreases, thereby reducing the voltage on the load. In contrast, when the current accumulated in the reactor L1 is greater than the current consumed by the load, the voltage on the load increases.

The amount of energy accumulated in the reactor L1 may be determined by the ratio between the on time and off time of the transistors S1 and S4 and transistors S2 and S3.

As described above, in the switching power supply according to the second embodiment shown in FIG. 11, the input terminal 6a and input terminal 6b of the AC/DC converter 3 are connected through the reactor L1. Thus, voltage step-up/down operations can be realized.

Next, the impedance conditions of the first capacitor C1, second capacitor C2, and reactor L1 will be described.

The respective impedances of the first capacitor C1 and second capacitor C2 are lower than or equal to the combined impedance of a parallel circuit formed by the load including the AC/DC converter, and the reactor at the switching frequency of the switching circuit.

By satisfying this condition, the input voltage of the switching circuit can be reliably transmitted to the load.

The impedance of the reactor is lower than or equal to the impedance of the load at the switching frequency of the switching circuit.

By satisfying this condition, the current can reliably flow through the load.

The impedance of the reactor is also lower than or equal to the combined impedance of the load at the switching frequency of the switching circuit.

By satisfying this condition, the input voltage of the switching circuit can be reliably transmitted to the load.

Alternatively, in the switching power supply according to the second embodiment, the load including the AC/DC converter may be formed by the AC/DC converter and a first load which is connected to the output of the AC/DC converter. In this case, the impedance of the reactor may be lower than or equal to the impedance of the load at the switching frequency of the switching circuit, and the impedance of the reactor may be an impedance such that an average reactor current equal to the maximum average power consumed by the load is generated.

### Third Embodiment

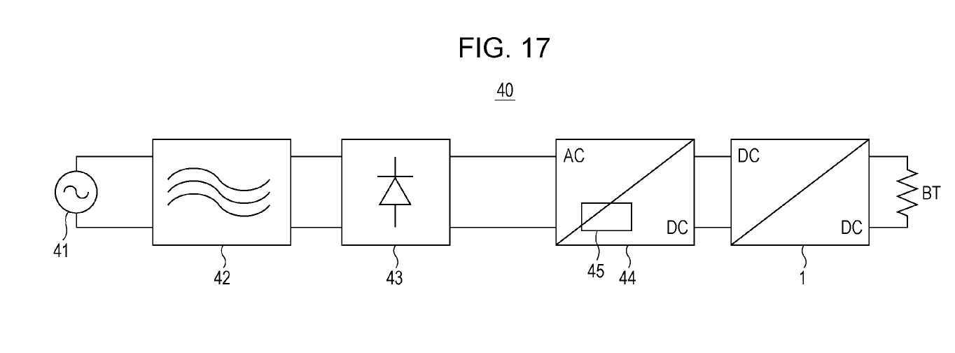

Next, a third embodiment will be described. FIG. 17 is a block diagram showing the configuration of a charging apparatus 40 according to the third embodiment.

The charging apparatus 40 includes an input filter 42, a rectifier circuit 43, an AC/DC converter 44, and the switching power supply 1 according to the first or second embodiment, which is a DC-DC converter.

The input filter 42 receives the alternating-current voltage of a commercial power supply 41. The input filter 42 passes only a predetermined frequency component of the alternating-current voltage (band pass filtration) and outputs it to the rectifier circuit 43.

The rectifier circuit 43 is, for example, a diode bridge circuit where four rectifier diodes are bridge-connected. The rectifier circuit 43 rectifies the alternating-current voltage outputted from the input filter 42 into an undulating voltage and outputs it.

The AC/DC converter 44 includes a power factor correction circuit (PFC circuit) 45. The PFC circuit 45 corrects the power factor of the alternating current-power outputted from the rectifier circuit 43. The AC/DC converter 44 converts the resulting alternating current into a direct current and outputs it.

The switching power supply 1 converts the direct-current voltage outputted from the AC/DC converter 44 into a predetermined direct-current voltage and charges a battery (e.g., in-car secondary battery) BT. At this time, the switching power supply 1 performs constant-current charge (CC charge) or constant-voltage charge (CV charge) while monitoring the output voltage and output current to the battery BT.

Note that charging the battery BT using a direct-current power supply does not require the input filter 42, rectifier circuit 43, or AC/DC converter 44.

As described above, the charging apparatus 40 includes the rectifier circuit 43, which rectifies an alternating-current voltage from the alternating-current power supply, the PFC circuit 45, which corrects the power factor of the output power of the rectifier circuit 43, and the switching power supply 1, which converts the output power of the PFC circuit 45 into direct-current power for charging the battery BT.

Since the charging apparatus 40 according to the third embodiment includes the switching power supply 1 according to the first or second embodiment, it provides functions and effects similar to those of the first or second embodiment.

Further, since the configurations of the first to third embodiments reduce di/dt and dv/dt of the transistors S1, S2, S3, and S4, noise transmitted to the power supply side can be reduced.

Note that the switching power supplies according to the first to third embodiments may be formed as bi-directional power supply circuits (e.g., bi-directional DC/DC converters).

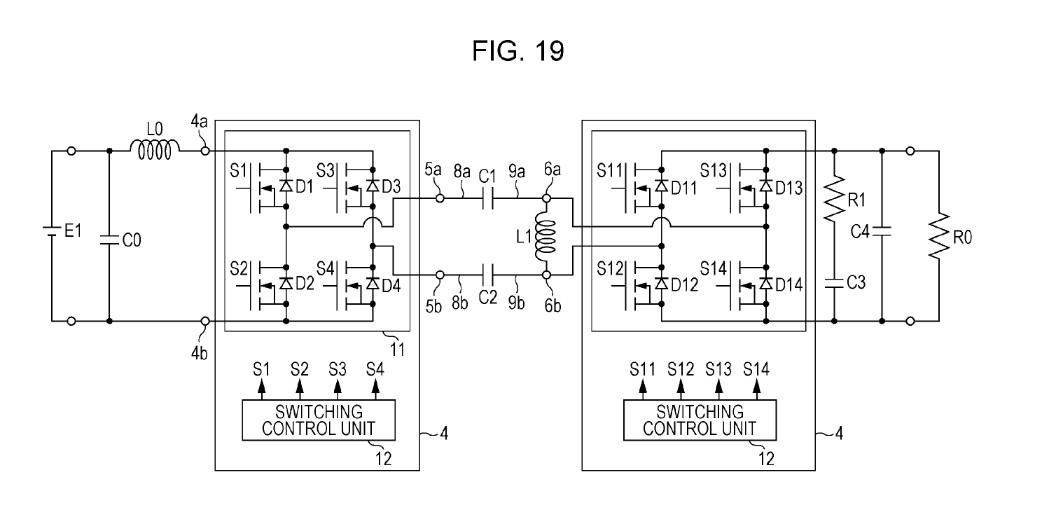

FIG. 19 is a diagram showing an example of a bi-directional DC/DC converter circuit. An example configuration shown in FIG. 19 includes converter circuits 4. The primary-side converter circuit 4 includes switching elements S1 to S4. The secondary-side converter circuit 4 includes switching elements S11 to 14. These switching elements are controlled by a corresponding switching control unit 12.

The present disclosure can be used, for example, as a charging apparatus for an in-car secondary battery.

While the present disclosure has been described with respect to exemplary embodiments thereof, it will be apparent to those skilled in the art that the disclosure may be modified in numerous ways and may assume many embodiments other than those specifically described above. Accordingly, it is intended by the appended claims to cover all modifications of the disclosure that fall within the true spirit and scope of the disclosure.

What is claimed is:

1. A switching power supply comprising:
a DC/AC inverter that includes a switching circuit that converts a received direct current into an alternating current;
an AC/DC converter that converts the alternating current into a direct current;
a first capacitor disposed in a first current path connecting one output of the DC/AC inverter and one input of the AC/DC converter, the first capacitor passing the alternating current;
a second capacitor disposed in a second current path connecting the other output of the DC/AC inverter and the other input of the AC/DC converter, the second capacitor passing the alternating current; and
a reactor disposed in a third current path connecting the one input and the other input of the AC/DC converter, the reactor passing part of an alternating current outputted from the DC/AC inverter, wherein
the AC/DC converter converts the alternating current, which the first capacitor and the second capacitor passed, into the direct current, and
an output voltage from the AC/DC converter is adjusted by a change of the period in which the reactor passes the part of the alternating current.

2. The switching power supply according to claim 1, wherein
the period in which the reactor passes the part of the alternating current is changed by a change of a ratio between on and off periods of a switching element included in the switching circuit.

3. The switching power supply according to claim 2, wherein
the switching circuit comprises a bridge circuit comprising a first connection path and a second connection path connected to the first connection path in parallel,
the first connection path comprises a first switching element and a second switching element connected to the first switching element in series,
the second connection path comprises a third switching element and a fourth switching element connected to the third switching element in series,
the first capacitor is connected to a path connecting the first switching element and the second switching element,
the second capacitor is connected to a path connecting the third switching element and the fourth switching element, and
the period in which the reactor passes the part of the alternating current is extended by an extension of at least one of a first period in which the first and fourth switching elements are on and the second and third switching elements are off and a second period in which the first and fourth switching elements are off and the second and third switching elements are on, to increase the output voltage from the AC/DC converter.

4. The switching power supply according to claim 1, wherein
respective impedances of the first and second capacitors are lower than or equal to a combined impedance of a parallel circuit formed by a load and the reactor at a switching frequency of the switching circuit, the load comprising the AC/DC converter, and
an impedance of the reactor is lower than or equal to an impedance of the load at the switching frequency of the switching circuit.

5. The switching power supply according to claim 1, wherein
the load comprising the AC/DC converter comprises the AC/DC converter and a first load connected to an output of the AC/DC converter, and
an impedance of the reactor is lower than or equal to an impedance of the load at a switching frequency of the switching circuit and is an impedance such that an average reactor current equal to maximum average power consumed by the load is generated.

6. A charging apparatus comprising a switching power supply,
the switching power supply comprising:
a DC/AC inverter that includes a switching circuit that converts a received direct current into an alternating current;
an AC/DC converter that converts the alternating current into a direct current;
a first capacitor disposed in a first current path connecting one output of the DC/AC inverter and one input of the AC/DC converter, the first capacitor passing the alternating current;
a second capacitor disposed in a second current path connecting the other output of the DC/AC inverter and the other input of the AC/DC converter, the second capacitor passing the alternating current; and
a reactor disposed in a third current path connecting the one input and the other input of the AC/DC converter, the reactor passing part of an alternating current outputted from the DC/AC inverter, wherein
the AC/DC converter converts the alternating current, which the first capacitor and the second capacitor passed, into the direct current, and
an output voltage from the AC/DC converter is adjusted by a change of the period in which the reactor passes the part of the alternating current.
